(19) United States
(12) Patent Application Publication
(10) Pub. No.: US 2024/0343194 A1
(43) Pub. Date: Oct. 17, 2024

(54) VEHICULAR VISION SYSTEM INCLUDING INTEGRATED INFOTAINMENT MODULE AND CAMERA

(71) Applicant: Magna Electronics Inc., Auburn Hills, MI (US)

(72) Inventor: Alan M. Cordeiro, Farmington Hills, MI (US)

(21) Appl. No.: 18/632,543

(22) Filed: Apr. 11, 2024

Related U.S. Application Data
(60) Provisional application No. 63/496,057, filed on Apr. 14, 2023.

(51) Int. Cl. B60R 1/24; G10L 15/22

(52) U.S. Cl. CPC B60R 1/24; G10L 15/22; B60R 2300/108

(57) ABSTRACT

A vehicular vision system includes a camera disposed at a vehicle and capturing image data, and an electronic control unit (ECU) having an image processor for processing image data captured by the camera. The system, responsive to processing by the image processor of image data captured by the camera, saves the image data to a circular buffer that has volatile memory. The vehicular vision system, responsive to a trigger condition indicating a deficiency in an advanced driving assistance feature of the vehicle, transmits, via wireless communication, the saved image data from the circular buffer to a remote server. The vehicular vision system, responsive to a user input, copies the saved image data from the circular buffer to non-volatile memory disposed within the vehicle.

### CROSS REFERENCE TO RELATED APPLICATION

The present application claims the filing benefits of U.S. provisional application Ser. No. 63/496,057, filed Apr. 14, 2023, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular vision system includes a camera disposed at a vehicle equipped with the vehicular vision system and viewing exterior of the equipped vehicle. The camera is operable to capture image data. The camera includes a CMOS imaging array with at least one million photosensors arranged in rows and columns. The system includes an electronic control unit (ECU) with electronic circuitry and associated software. The electronic circuitry of the ECU includes an image processor operable to process image data captured by the camera and transferred to the ECU. The vehicular vision system, responsive to processing by the image processor of image data captured by the camera, saves the image data to a circular buffer, and wherein the circular buffer that includes volatile memory. The vehicular vision system, responsive to a trigger condition indicating a deficiency in an advanced driving assistance feature of the equipped vehicle, transmits via wireless communication the saved image data from the circular buffer to a remote server located remote from the equipped vehicle. The vehicular vision system, responsive to a user input, copies the saved image data from the circular buffer to non-volatile memory disposed within the equipped vehicle.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a block diagram of dash cam system; and

FIG. 3 is a block diagram of the vision system of FIG. 1 with integrated dash cam functionality.

### DESCRIPTION OF THE PREFERRED EMBODIMENTS

Most vehicles include an infotainment electronic module that provides features such as radio and other audio entertainment, phone connectivity services, etc. Many vehicles are also equipped with one or more Automated Driver Assistance Systems (ADAS) modules that provide various safety assistance features to the driver (e.g., lane centering, automatic emergency braking, collision avoidance, pedestrian detection, etc.). These modules generally include a high resolution front facing camera. Dash cams are popular equipment for vehicles as they allow for recording video images representative of the environment around the vehicle. Conventionally, these dash cams are aftermarket purchases that vehicle owners add to the vehicle at additional cost. These dash cams are often difficult to integrate cleanly and mount securely.

While some infotainment systems have the ability to allow vehicle owners to add additional memory through a USB connection, these infotainment systems do not include a camera (e.g., a front viewing camera, a rear viewing camera, one or more side viewing cameras, an interior driver monitoring camera, etc.). Moreover, while ADAS systems often include a front facing camera as part of their sensor suite, they lack any external memory port to allow for an expansion of storage space. By providing the infotainment system access to one or more camera modules of the ADAS, a dash cam feature can be delivered to end users with minimal additional cost.

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

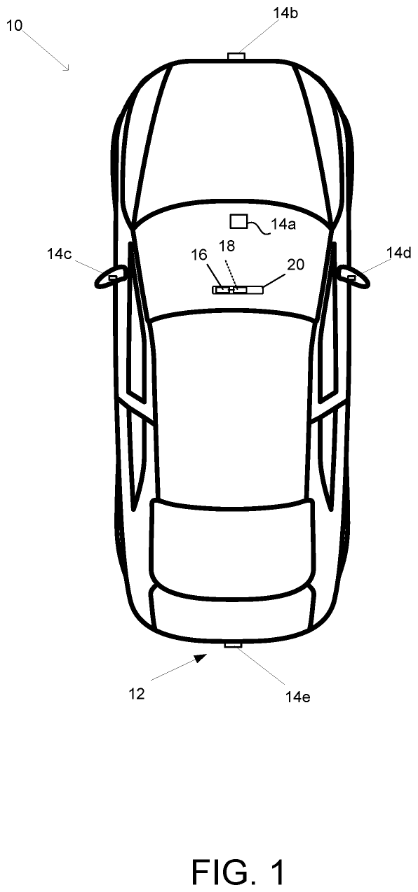

Referring now to the drawings and the illustrative embodiments depicted therein, a vehicle 10 includes an imaging system or vision system 12 that includes at least one exterior viewing imaging sensor or camera, such as a rearward viewing imaging sensor or camera 14a mounted at a windshield of the vehicle and viewing forward of the vehicle (and the system may optionally include multiple exterior viewing imaging sensors or cameras, such as a forward viewing camera 14b at the front of the vehicle, a sideward/rearward viewing camera 14c, 14d at respective sides of the vehicle, and/or a rearward facing camera 14e), which captures images exterior of the vehicle, with the camera having a lens for focusing images at or onto an imaging array or imaging plane or imager of the camera (FIG. 1). Optionally, the forward viewing camera views through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Traditionally the infotainment module and ADAS module are delivered to automobile manufacturers as individual modules. By combining these two services into one electronic module, there may be additional cost savings from packaging and sharing of internal resources. Additionally, the combined capabilities of the single module allow the dash cam feature to be added at very little additional cost, since all the critical components needed for implementing the dash cam feature are already present in the combination module. Additionally, conventional dash cams are often aesthetically displeasing. Accordingly, implementations herein include a vision system that uses integrated cameras for both ADAS functionality and dash cam functionality in conjunction with an infotainment module in a combined electronic module.

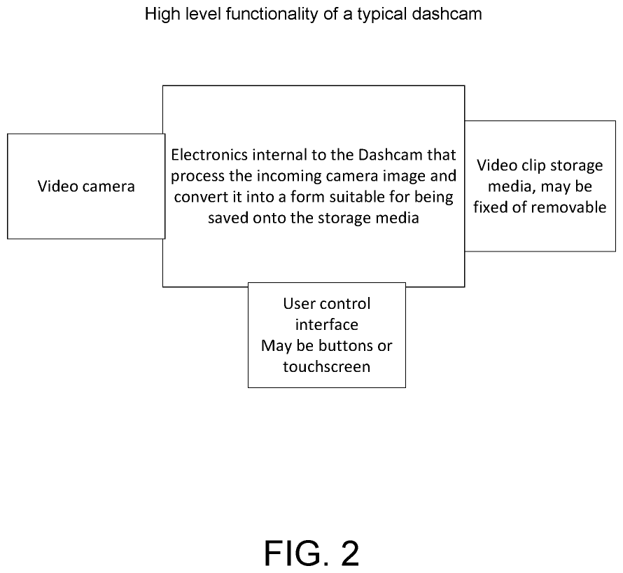

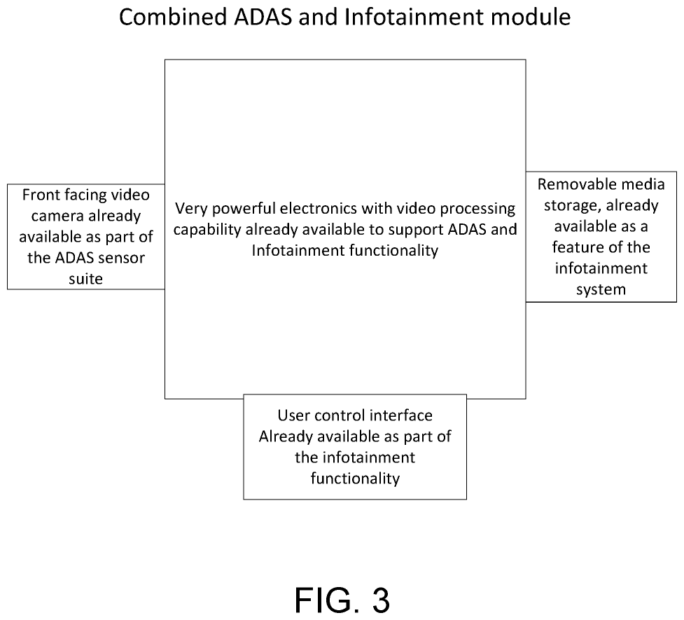

FIG. 2 illustrates a design of a conventional dash cam module. Here, a dash cam includes internal electronics that process image data captured by the dash cam and convert it to a form suitable for being saved onto storage media. The dash cam includes fixed or removable storage media and a user interface (e.g., buttons or a touchscreen) that may be integrated into the dash cam. In contrast, FIG. 3 illustrates the components of the vision system described herein that provides dash cam functionality using a combination ADAS and infotainment system module.

The system is capable of continuously buffering a predetermined amount of video (e.g. 15-120 seconds such as 30 seconds of “flight recorder” video) to allow saving videos of unexpectedly interesting events without any manual activation of the system required. An example of such an event includes a meteor crossing the sky in front of the vehicle. Thus, when recording is activated, the system may already have the predetermined amount of video captured. Besides the video in the buffer, the saved video clip may also include some additional time after the “save” button (or other user input/trigger) is pressed. This buffered time and/or the additional amount of time may be configurable (e.g., by a user of the vehicle). For example, in response to a user input, the system saves both a first predetermined amount of video captured prior to the user input (e.g., 30 seconds) and a second predetermined amount of video the system continues to capture after the user input is received. The first predetermined amount of video may be the same or different from the second predetermined amount of video. The videos may be saved using a default file name including the time and date of the start of the video clip for easier cataloging. The system also enables preserving the video evidence of events just prior to a crash or other accident.

The video buffer may also be saved and uploaded to a remote server (e.g., using a wireless communication module via the Internet and/or via a mobile device in communication with the vehicle, such as a mobile phone) automatically for certain events when the ADAS system believes a corner case event has occurred that the ADAS system is not properly or adequately trained to respond to (i.e., the ADAS has a deficiency or error or shortcoming). For example, when an automatic braking system (AEB) triggers when it should not (i.e., no braking event was necessary) or fails to trigger when it should (i.e., the driver had to manually engage the brakes in an emergency braking maneuver when the AEB did not attempt to brake), the system may upload video of the event (and any number of seconds prior to or after the event) automatically to evaluate the performance of the AEB and/or provide additional training data for the AEB. That is, the system may enable the automatic gathering of training samples or validation data or verification data (via captured and uploaded image data) in response to a potential or possible deficiency or error or fault in an ADAS to measure and/or improve the performance and robustness of the ADAS. The system may upload data from other sensors as well (e.g., GPS data to determine a location of the vehicle, radar data, metadata such as timestamps, etc.) in order to correlate and/or evaluate the image data. The image data may be annotated and used as a training sample to train or retrain machine learning models used in the ADAS.

The user may be able to enable/disable the automatic upload feature (e.g., via privacy settings) and/or configure scenarios in which the feature is enabled. The system may upload additional data along with the image data to further enhance the value of the training samples. For example, the system may upload a location of the vehicle (e.g., captured via a GPS sensor) along with the image data. The system may upload data from other sensors as well, such as data from radar sensors, lidar sensors, ultrasonic sensors, microphones (for audio data), etc. The system may record image data from multiple cameras aside from the forward viewing camera. For example, the system may record image data captured by a rearward viewing camera or one or more surround view cameras (e.g., disposed at side mirrors of the vehicle). The system may include illumination sources to allow recording in low light conditions. The illumination sources may be visible light or non-visible light (e.g., ultraviolet light). The system may upload the date and time and any known environmental factors along with the image data (e.g., temperature, humidity, ambient light levels, etc.). One or more ADAS features may be trained (e.g., machine learning models of the features may be trained) using training samples derived from the information uploaded.

The system may upload the information automatically based on the triggering of any number of conditions. Optionally, the automatic gathering/uploading is triggered based at least in part on a user input, based at least in part on processing of image data captured by the camera, and/or based at least in part on processing of sensor data captured by other sensors in the vehicle (e.g., radar sensors, lidar, GPS sensors, accelerometers, etc.). For example, the system may determine a deficiency in the ADAS of the vehicle via processing of sensor data captured by a sensor of the vehicle, or braking or steering events that exceed a threshold may trigger the system. Optionally, the automatic gathering/uploading is based on outputs of the ADAS. For example, when an output of the ADAS satisfies a threshold, the system may automatically gather/upload image data to evaluate the performance of the ADAS. An object detected within a threshold distance of the vehicle may trigger the system. Collisions or other damage to the vehicle or detection of an accident (involving the equipped vehicle or another vehicle detected by the system) may trigger the system. The driver may manually trigger the system when the driver observes sub-optimal behavior from an ADAS feature. For example, when the a lane keeping or lane centering feature allows the vehicle to drift into another lane (e.g., due to poor lane markings), the driver may indicate to the system (e.g., via a button, via a voice command, or via in any user input) that the information (e.g., the previous 30 seconds or the previous 60 seconds of sensor data) should be uploaded as feedback to improve the feature.

Because the internal on-board storage is necessarily limited in size and may have a limited number of write cycles permitted before wearing out, the dash cam functionality may only be available when an external removable storage media device such as a USB thumb drive, a Secure Digital (SD) card, etc., is plugged into an external port that is in communication with the vision system. The external storage may enable the dash cam feature to record, for example, long videos of scenic drives or driving on a challenging test track course. The infotainment system may include hard keys or virtual touch screen keys and menus to allow a user to control the dash cam functionality. Optionally, the user may control the system via other means, such as via voice commands, gestures, or via a mobile device (e.g., a key fob or mobile phone).

The dash cam functionalities may be integrated with any number of cameras installed at the vehicle. The user may configure which cameras the system captures data from in the event of a triggering event. For example, the user may configure the system to only capture image data from a forward viewing camera (such as a forward viewing camera disposed at the windshield of the vehicle and viewing through the vehicle or such as a forward viewing camera disposed at a front portion of the vehicle). Alternatively, the user may configure the system to capture image data from a rearward viewing camera, one or more sideward viewing cameras, and/or an interior viewing camera. The system may automatically determine which camera(s) to capture image data from based on the triggering event. For example, detecting an object within a threshold distance of the vehicle to the left of the vehicle may trigger the system to capture image data using a left viewing camera (e.g., disposed at the driver side mirror). The user may trigger the system remotely (e.g., via an interaction with a mobile phone or other device).

For the limited video buffering feature (i.e., the continuous recording of, for example, 30 seconds or 60 seconds or 90 seconds or 120 seconds of image data), the buffered video image data may reside in internal RAM memory of the vision system to limit writes to internal/external non-volatile memory (e.g., to reduce ware from write cycles). The system may store the continuous recording to a circular buffer of a threshold size. When the circular buffer is full, the system begins to overwrite the oldest data in the circular buffer. For example, when the circular buffer is of sufficient size to store 60 seconds of image data, the system, after recording 60 seconds of image data and filling the circular buffer, begins to overwrite the oldest recorded data, such that the previous 60 seconds of image data is always available.

In the event the user wishes to save the last few seconds of previously recorded video along with some additional seconds, the user may command the system via a dash cam user interface. For example, the user may select a “save” button that saves any data in RAM already recorded (i.e., from the continuous recording feature) along with any amount of future data the user desires. The save button may transfer the data in RAM to non-volatile memory for permanent storage (e.g., internal non-volatile memory or external non-volatile memory provided by the user, such as a USB stick or an SD card). The save button may be easily accessible with minimal key strokes from any menu display or from a hard button on the console/steering wheel or available via voice command.

Thus, it is advantageous for some automotive operators to provide a dash cam feature in a vehicle that allows the operators to record high resolution video of the scenes around the vehicle. Available aftermarket products must be installed by vehicle owners. This takes additional space within the vehicle and installation is often difficult and/or decreases an aesthetic appeal of the vehicle (e.g., from exposed wires, the camera mounting, etc.). The vision system discussed herein includes an infotainment system and an ADAS system that collaborate and interconnect to provide a dash cam feature. Optionally, the infotainment system and the ADAS feature are co-located on the same printed circuit board (PCB) or on the same integrated chip (IC). That is, the dash cam functionality may be co-located with ADAS functionality such that each is processed using the same processor or other components. Thus, the system provides dash cam functionality with minimal additional added parts, which decreases cost and increases reliability. The system may utilize aspects of the vision system described in U.S. Pat. No. 10,819,943, which is hereby incorporated by reference in its entirety.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels or at least three million photosensor elements or pixels or at least five million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular vision system, the vehicular vision system comprising:
a camera disposed at a vehicle equipped with the vehicular vision system and viewing exterior of the equipped vehicle, wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor operable to process image data captured by the camera and transferred to the ECU;
wherein the vehicular vision system, responsive to processing by the image processor of image data captured by the camera, saves the image data to a circular buffer, and wherein the circular buffer comprises volatile memory;
wherein the vehicular vision system, responsive to a trigger condition indicating a deficiency in an advanced driving assistance feature of the equipped vehicle, transmits via wireless communication the saved image data from the circular buffer to a remote server located remote from the equipped vehicle; and
wherein the vehicular vision system, responsive to a user input, copies the saved image data from the circular buffer to non-volatile memory disposed within the equipped vehicle.

2. The vehicular vision system of claim 1, wherein the trigger condition comprises determining the deficiency in the advanced driving assistance feature of the equipped vehicle via processing, by the vehicular vision system, sensor data from a sensor of the equipped vehicle, and wherein the sensor is different from the camera.

3. The vehicular vision system of claim 2, wherein the sensor comprises at least one selected from the group consisting of (i) an acceleration sensor, (ii) a braking sensor and (iii) a steering sensor.

4. The vehicular vision system of claim 1, wherein the vehicular vision system, responsive to the trigger condition, transfers sensor data from one or more additional sensors from the circular buffer to the remote server.

5. The vehicular vision system of claim 4, wherein the one or more additional sensors comprises at least one selected from the group consisting of (i) a GPS sensor, (ii) a radar sensor, (iii) a lidar sensor, (iv) an ultrasonic sensor, (v) a temperature sensor and (vi) an ambient light sensor.

6. The vehicular vision system of claim 1, wherein the non-volatile memory comprises internal non-volatile memory.

7. The vehicular vision system of claim 1, wherein the non-volatile memory comprises external non-volatile memory that is connected to the vehicular vision system via a Universal Serial Bus (USB) connection.

8. The vehicular vision system of claim 1, wherein the user input comprises a voice command from an occupant of the equipped vehicle.

9. The vehicular vision system of claim 1, wherein the camera comprises a forward-viewing camera disposed at the windshield of the equipped vehicle.

10. The vehicular vision system of claim 1, wherein the advanced driving assistance feature of the equipped vehicle comprises at least one selected from the group consisting of (i) an automatic emergency braking system, (ii) an object detection system, (iii) an automatic cruise control system and (iv) a lane keeping system.

11. The vehicular vision system of claim 1, comprising a plurality of cameras, and wherein image data captured by the plurality of cameras is transferred to the ECU, and wherein the vehicular vision system, responsive to processing by the image processor of image data captured by the plurality of cameras, saves the image data from at least two cameras of the plurality of cameras to the circular buffer.

12. The vehicular vision system of claim 11, wherein the at least two cameras are selected by a user of the vehicle.

13. The vehicular vision system of claim 1, wherein the trigger condition comprises a second user input.

14. The vehicular vision system of claim 1, wherein the trigger condition comprises an indication of an accident.

15. The vehicular vision system of claim 1, wherein the trigger condition comprises an object within a threshold distance of the equipped vehicle.

16. A vehicular vision system, the vehicular vision system comprising:
a camera disposed at a vehicle equipped with the vehicular vision system and viewing exterior of the equipped vehicle, wherein the camera is operable to capture image data;
wherein the camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor operable to process image data captured by the camera and transferred to the ECU;
wherein the vehicular vision system, responsive to processing by the image processor of image data captured by the camera, saves the image data to a circular buffer, and wherein the circular buffer comprises volatile memory;
wherein the vehicular vision system, responsive to a trigger condition indicating a deficiency in an advanced driving assistance feature of the equipped vehicle, transmits via wireless communication the saved image data from the circular buffer to a remote server located remote from the equipped vehicle, and wherein the trigger condition comprises determining the deficiency in the advanced driving assistance feature of the equipped vehicle via processing, by the vehicular vision system, sensor data from a sensor of the equipped vehicle, and wherein the sensor is different from the camera; and
wherein the vehicular vision system, responsive to a user input, copies the saved image data from the circular buffer to non-volatile memory disposed within the equipped vehicle, and wherein the non-volatile memory comprises external non-volatile memory that is connected to the vehicular vision system via a Universal Serial Bus (USB) connection.

17. The vehicular vision system of claim 16, wherein the sensor comprises at least one selected from the group consisting of (i) an acceleration sensor, (ii) a braking sensor and (iii) a steering sensor.

18. The vehicular vision system of claim 16, wherein the vehicular vision system, responsive to the trigger condition, transfers sensor data from one or more additional sensors from the circular buffer to the remote server.

19. The vehicular vision system of claim 16, wherein the non-volatile memory comprises internal non-volatile memory.

20. A vehicular vision system, the vehicular vision system comprising:
a forward-viewing camera disposed at a vehicle equipped with the vehicular vision system and viewing exterior of the equipped vehicle, wherein the forward-viewing camera is operable to capture image data;
wherein the forward-viewing camera comprises a CMOS imaging array, and wherein the CMOS imaging array comprises at least one million photosensors arranged in rows and columns;
an electronic control unit (ECU) comprising electronic circuitry and associated software;
wherein the electronic circuitry of the ECU comprises an image processor operable to process image data captured by the forward-viewing camera and transferred to the ECU;
wherein the vehicular vision system, responsive to processing by the image processor of image data captured by the forward-viewing camera, saves the image data to a circular buffer, and wherein the circular buffer comprises volatile memory;
wherein the vehicular vision system, responsive to a trigger condition indicating a deficiency in an advanced driving assistance feature of the equipped vehicle, transmits via wireless communication, (i) the saved image data from the circular buffer to a remote server located remote from the equipped vehicle and (ii) sensor data from one or more additional sensors from the circular buffer to the remote server; and
wherein the vehicular vision system, responsive to a user input, copies the saved image data from the circular buffer to non-volatile memory disposed within the equipped vehicle.

21. The vehicular vision system of claim 20, wherein the one or more additional sensors comprises at least one selected from the group consisting of (i) a GPS sensor, (ii) a radar sensor, (iii) a lidar sensor, (iv) an ultrasonic sensor, (v) a temperature sensor and (vi) an ambient light sensor.

22. The vehicular vision system of claim 20, comprising a plurality of cameras, and wherein image data captured by the plurality of cameras is transferred to the ECU, and wherein the vehicular vision system, responsive to processing by the image processor of image data captured by the plurality of cameras, saves the image data from at least two cameras of the plurality of cameras to the circular buffer.

23. The vehicular vision system of claim 22, wherein the at least two cameras are selected by a user of the vehicle.
